(19) United States
(12) Patent Application Publication
(10) Pub. No.: US 2003/0195936 A1
(43) Pub. Date: Oct. 16, 2003

(54) Mail extracting method of handheld device

(76) Inventors: Ho-Lung Lu, Panchiao City (TW); Yuan Lung Chang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/119,737

(22) Filed: Apr. 11, 2002

(51) Int. Cl. G06F 15/16

(52) U.S. Cl. 709/207; 709/206

(57) ABSTRACT

The present invention provides a mail extracting method of handheld device. First, a multimedia agent is used to access an e-mail from the mail host. The e-mail is then compared with mail extracting rules in a mail extracting rule database via a filter to extract a mail with appropriate format. Next, the mail with appropriate format is stored into a memory. Finally, the mail with appropriate format is transmitted to the handheld device. The mail extracting method finds out the content type of the e-mail via the key-tag thereof, accesses the mail type defined in the content type, and then checks the mail type to determine whether it conforms to the mail extracting rules in the mail extracting rule database. If the answer is positive, the e-mail is extracted to be a mail with appropriate format.

### FIELD OF THE INVENTION

The present invention relates to a mail extracting method of handheld device and, more particularly, to a method making use of a handheld device (e.g., a personal digital assistant (PDA) or a mobile phone) to access an e-mail in a computer or on a data network, and extract the content of the e-mail suitable for displaying on the handheld device.

### BACKGROUND OF THE INVENTION

Handheld devices are small portable electronic devices like PDAs, mobile phones, palm computers, etc. Generally speaking, the handheld device cannot directly access network, and needs another accessory device to achieve network access. Moreover, because the capacity of the inbuilt memory of the handheld device is very small, even if it can access network, the contents of e-mails only can be read on the network, but the e-mails cannot be downloaded that results in much inconvenience.

Besides, in addition to text information, an e-mail usually has some appended files, such as JPEG picture files, MPEG video files, or execution files. Although there is no problem to access these appended files on a general computer, if the handheld device is used to access the e-mail, these appended files may not be downloaded or the handheld device may be crashed because these appended files are large and the memory of the handheld device is insufficient. And, it is not able to inquire about whether there are appended files therein or how large these appended files are in advance when accessing an e-mail. This is thus a difficult problem to be solved.

Accordingly, the present invention aims to propose a mail extracting method of handheld device, whereby a mail host on a data network can be connected directly or via a computer so that the e-mails can be accessed and the content suitable for displaying on a handheld device can be extracted.

### SUMMARY OF THE INVENTION

The primary object of the present invention is to provide a mail extracting method of handheld device, whereby a mail host can be accessed via a computer or a data network so that the content of an e-mail suitable for displaying on a handheld device can be extracted.

The secondary object of the present invention is to provide a mail extracting method of handheld device, which can connect with a computer or a data network in wired or wireless transmission way. Wired transmission is achieved by means of RS-232 or universal serial bus (USB). Wireless transmission is achieved by means of infrared or radio-frequency (RF) transmission.

Another object of the present invention is to provide a mail extracting method of handheld device, which can discriminate and classify downloaded e-mails in advance and then store them so that a handheld device can extract a suitable e-mail for reading or only access a small part of the e-mail.

The present invention provides a mail extracting method of handheld device. First, a multimedia agent is used to access an e-mail in a mail host. Then, extracting a mail with appropriate format from the e-mail via a filter by comparing the e-mail with the extracting rule in the mail extracting rule database. mail with appropriate format Next, the mail with appropriate format is stored into the memory. Finally, the mail with appropriate format is transmitted to the handheld device.

The present invention is also characterized in that the mail extracting method is to find out the content type of the e-mail via the key-tag thereof, access the mail type defined in the content type, and then judge whether the mail type conforms to the extracting rule in the mail extracting rule database. If the answer is positive, a mail with appropriate format will be extracted from the e-mail.

The various objects and advantages of the present invention will be more readily understood via the following detailed description in conjunction with the appended drawings.

### BRIEF DESCRIPTION OF THE DRAWINGS

FIG. 1 is a system architecture diagram of the present invention;

FIG. 2 is a mail accessing flowchart of the mail host of the present invention; and

FIG. 3 is a flowchart of the mail extracting method of the present invention.

### DETAILED DESCRIPTION OF THE PREFERRED EMBODIMENT

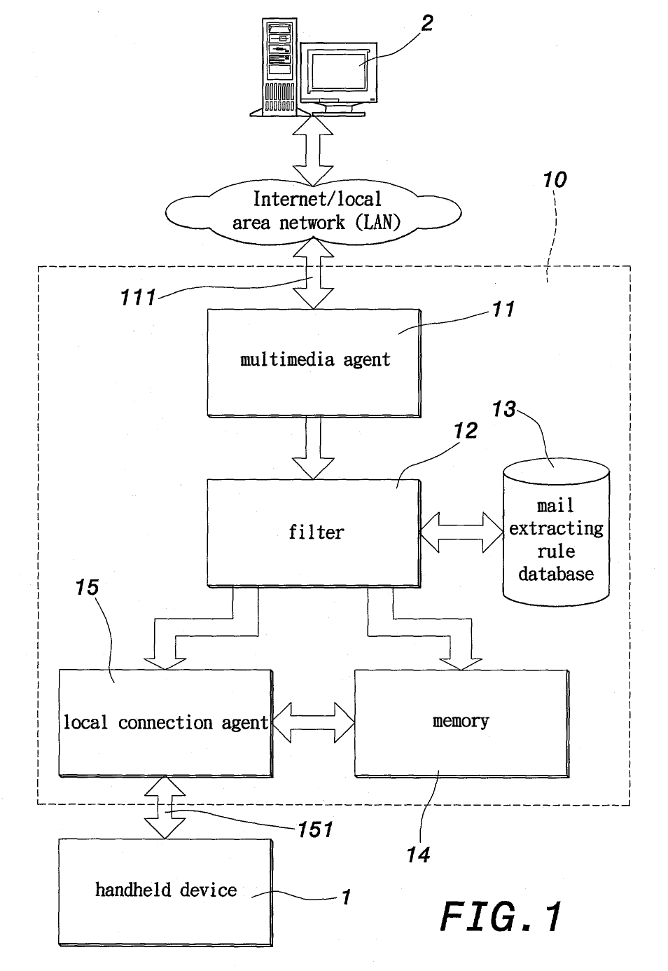

In the present invention, the preferred embodiment is described with employing the PDA. Please refer to the FIG. 1, which is the system architecture diagram of the present invention. The mail extracting device 10 of the present invention is mainly designed to extract the e-mail 21 in the mail host 2 for a handheld device 1. The mail host 2 can be a mail server of Internet mail service provider, or a mail server of local area network (LAN). The mail extracting device 10 is formed by assembling a multimedia agent 11, a filter 12, a mail extracting rule database 13, a memory 14, and a local connection agent 15. The multimedia agent 11 is connected to the mail host 2 via a wired or wireless transmission interface 111 to access the e-mail 21 of the mail host 2. The multimedia agent 11 accesses or sends the e-mail 21 of the mail host 2 according to protocol of POP3 and SMPT. The transmission interface 111 for connecting the multimedia agent 11 to the mail host 2 can be a wired or wireless transmission interface like Ethernet interface, modem interface, USB interface, RS-232 interface, IrDA transmission interface, or RF transmission interface.

The filter 12 is connected to the multimedia agent 11 to extract a mail with appropriate format from the e-mail 21 accessed by the multimedia agent 11 so that the mail with appropriate format can be transmitted to the handheld device 1. The filter 12 is provided with the mail extracting rule database 13. The mail extracting rules stored in the database 13 can be dynamically modified. The filter 12 compares the accessed e-mail 21 with the mail extracting rules in the mail extracting rule database 13 one by one to determine whether the e-mail is suitable for displaying on the handheld device 1. The mail extracting rules can be added or modified to meet the requirements of future compatibility and expansibility.

The memory 14 is connected to the filter 12 for storing the mail with appropriate format extracted by the filter 12. The memory 14 is composed of nonvolatile memory devices. The local connection agent 15 is connected to the filter 12, the memory 14 and the handheld device 1 to transmit the mail with appropriate format in the filter 12 or the memory 14 to the handheld device 1. A connection interface 151 for connecting the local connection agent 15 to the handheld device 1 can be an IrDA transmission interface, a blue-tooth transmission interface, an 802.11 transmission interface, a USB interface, an RS-232 interface, an EPP interface, or a 1394 interface. In order to keep exactness and confidentiality of data transmission between the local connection agent 15 and the handheld device 1, an encrypting/decrypting software or an encoding/decoding software can be added in the filter 12 and the handheld device 1.

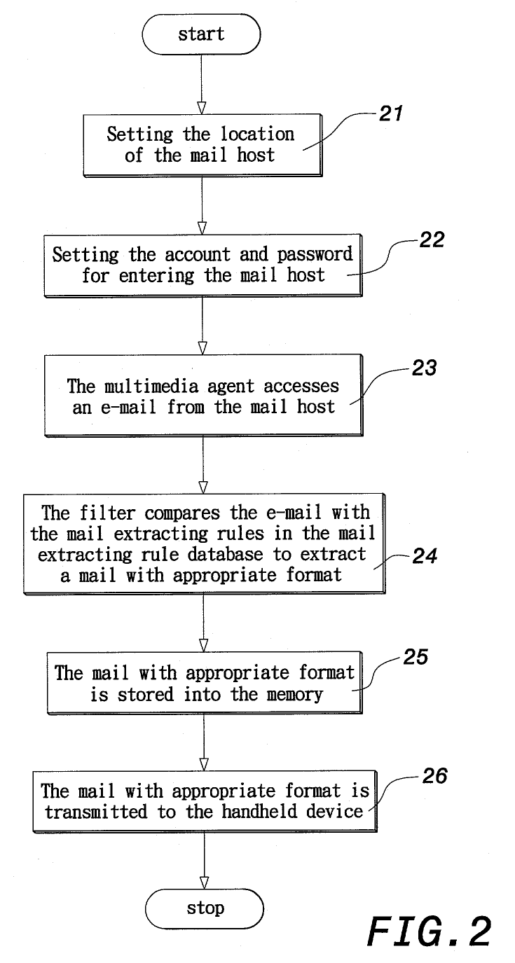

As shown in FIG. 2, the method of extracting the e-mail 21 in the mail host 2 comprises the following steps.

Step 21: setting the location of the mail host 2 of the multimedia agent 11;

Step 22: setting the account and password of the multimedia agent 11 for entering the mail host 2;

Step 23: The multimedia agent 11 accesses the e-mail 21 that belongs to the user in the mail host 2;

Step 24: The accessed e-mail 21 are compared with the mail extracting rules in the mail extracting rule database 13 by the filter 12 to extract a mail with appropriate format suitable for displaying on the handheld device 1;

Step 25: The mail with appropriate format is stored in the memory 14;

Step 26: The mail with appropriate format is directly transferred to the handheld device 1.

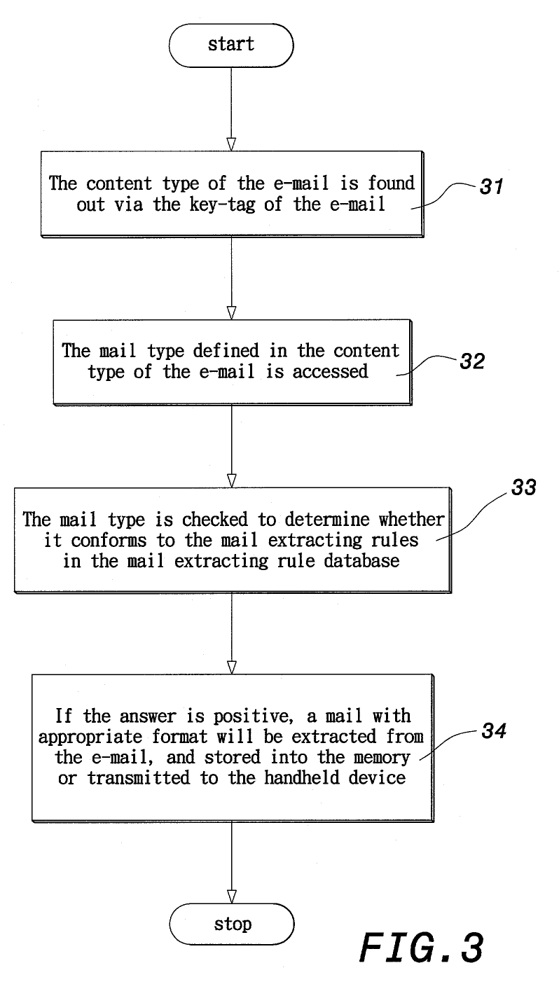

As shown in FIG. 3, the mail extracting method of the present invention comprises the following steps.

Step 31: The content type of the e-mail 21 is first found out via the key-tag of the e-mail 21. The e-mail 21 used in the Internet is of standard specification, i.e., multipurpose Internet mail extensions (MIME). The content type of the e-mail 21 includes text, HTML or XML, image, audio, video, application, and so on;

Step 32: The mail type defined in the content type of the e-mail 21 is then accessed;

Step 33: The mail type is checked to determine whether it conforms to the mail extracting rules in the mail extracting rule database 13;

Step 34: If the mail type conforms to the mail extracting rules, the e-mail 21 is extracted to be a mail with appropriate format, which can be stored in the memory 14 or transferred to the handheld device 1.

To sum up, the mail extracting method of handheld device of the present invention is used to connect to a computer or a data network so as to access an e-mail in a mail host and extract a mail with appropriate format suitable for displaying on a handheld device.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A mail extracting method of a handheld device at least comprising the steps of:
(a) a multimedia agent accessing an e-mail in a mail host;
(b) comparing said e-mail with mail extracting rules in a mail extracting rule database by a filter to extract a mail with appropriate format; and
(c) transmitting said mail with appropriate format to said handheld device.

2. The mail extracting method of a handheld device as claimed in claim 1, wherein said step (a) further comprises the steps of:
(a) setting the location of said mail host of said multimedia agent; and
(b) setting the account and password of said multimedia agent for entering said mail host.

3. The mail extracting method of a handheld device as claimed in claim 1, wherein the extracting of said mail with appropriate format by said filter in is said step (b) further comprises the steps of:
(a) finding out a content type of said e-mail via a key-tag thereof;
(b) accessing a mail type defined in said content type;
(c) checking said mail type to determine whether it conforms to the mail extracting rules in said mail extracting rule database; and
(d) extracting said mail with appropriate format from said e-mail if said mail type conforms to the mail extracting rules.

4. The mail extracting method of a handheld device as claimed in claim 3, wherein the content type of e-mail in said step (a) includes text, HTML or XML, image, audio, video, and application.

5. The mail extracting method of a handheld device as claimed in claim 1 further comprising a step for storing said mail with appropriate format into a memory after said step (b).

6. The mail extracting method of a handheld device as claimed in claim 1, wherein said multimedia agent accesses the e-mail from or sends the e-mail to said mail host according to protocols of POP3 and SMPT.
